(19) United States
(12) Patent Application Publication
(10) Pub. No.: US 2023/0090476 A1
(43) Pub. Date: Mar. 23, 2023

(54) NFT DISPLAY DEVICE AND NFT HOLOGRAPHIC PROJECTOR

(71) Applicant: PULSION CAPITAL LIMITADA, San Jose (CR)

(72) Inventors: Manuel Fernando Yglesias Mora, San Jose (CR); Diego Xirinachs Jimenez, Heredia (CR)

(73) Assignee: PULSION CAPITAL LIMITADA, San Jose (CR)

(21) Appl. No.: 17/950,837

(22) Filed: Sep. 22, 2022

(30) Foreign Application Priority Data
Sep. 22, 2021 (CR) 2021-0000487
Sep. 22, 2021 (CR) 2021-0000488

(51) Int. Cl. G03H 1/00; H04L 9/32; G06Q 20/36

(52) U.S. Cl. CPC G03H 1/0005; H04L 9/3213; G06Q 20/36; G03H 2001/0088; G06Q 2220/00

(57) ABSTRACT

An NFT display device having a user interface touch system, a monitor, and a storage unit and processor stored within a housing, in which the housing includes a power button, a USB port and a power connector port for supplying power to the NFT display device. Moreover, the disclosure describes an NFT holographic projector that includes a hologram projection lens, as well as a touch interface, a monitor, and a storage unit and processor stored within a housing in which the housing includes a power button, a USB port, and a power connector port for supplying power to the NFT holographic projector.

### BACKGROUND OF THE INVENTION

### Field of the Invention

The present invention relates to an NFT display device and NFT holographic projector.

### Discussion of the Background

NFT: Non-Fungible Token. It is a digital data reservoir linked to a unique identification granted through blockchain technology. The unique identification guarantees that the contained digital file is authentic. The NFT requires a processor and a storage element in order to be displayed. The included software must download a copy of the Blockchain registry, which is a database of all transactions related to that specific Token, and thus validate that the NFT being displayed is authentic. This requires an internet connection, at least to validate the information contained within the NFT.

Blockchain: The blockchain is a list of records (called blocks) that are interlinked using cryptography. Each block contains a cryptographic key that proves that the block has been generated using the mathematical algorithms corresponding to that type of block, which generates a guarantee of authenticity.

Virtual wallet: The virtual wallet is a software component that creates a master seed, which allows certain blocks of the blockchain to be linked to that master seed, to test and maintain ownership of said blocks.

Currently, the most widespread technical application of NFTs is its use in works of art. These works of art are often paintings or multimedia files. Any piece of art is susceptible of being converted into an NFT. It would be desirable to have a mechanism that facilitates the continuous projection of the work of art so that the work in question can be displayed and viewed by others.

### SUMMARY OF THE INVENTION

The NFT display device comprises a playback system that contains a user interface component (e.g., touch screen) a storage device, and an audiovisual output device such as a monitor. The user interface component uses virtual wallet access software (for example, the so-called MetaMask), which allows the user to access different virtual wallets and choose one. The interface component stores the blockchain information to validate the authenticity of the virtual wallet and its contents, and the user can then choose a virtual wallet and an NFT within it. Once an NFT has been chosen, the device stores the information in its memory, closes the internet connection and displays the image of the chosen NFT. The NFT display device can read information directly from the blockchain, as well as access a virtual wallet, to project NFTs that belong to the owner of the wallet being read.

The NFT holographic projector, on the other hand, comprises a holographic projection system that contains a user interface component, a storage device, and a holographic projection device. The user interface component uses virtual wallet access software (for example, the so-called Meta Mask), which allows the user to access different virtual wallets and choose one. The interface component stores the blockchain information to validate the authenticity of the virtual wallet and its contents, and the user can then choose a virtual wallet and an NFT within it. Once an NFT has been chosen, the device stores the information in its memory, closes the internet connection and displays the holographic image of the chosen NFT. The hologram lens can read information directly from the blockchain, as well as access a virtual wallet, to project NFTs belonging to the owner of the wallet being read.

### BRIEF DESCRIPTION OF THE DRAWINGS

FIG. 1 is a flowchart of the steps to display an NFT on the monitor component of the NFT display device, in accordance with the principles of the present invention.

FIG. 2 shows a perspective view of the NFT display device.

FIG. 3 shows a front view of the NFT display device.

FIG. 4 shows a side view of the NFT display device.

FIG. 5 is a flowchart of the steps to display an NFT on the holographic projection lens component of the NFT projector, in accordance with the principles of the present invention.

FIG. 6 shows a perspective view of the NFT holographic projector.

FIG. 7 shows a front view of the NFT holographic projector.

FIG. 8 shows a side view of the NFT holographic projector.

### DETAILED DESCRIPTION OF THE INVENTION

The present disclosure relates to an NFT display device and NFT holographic projector, as further described below.

A. NFT Display Device

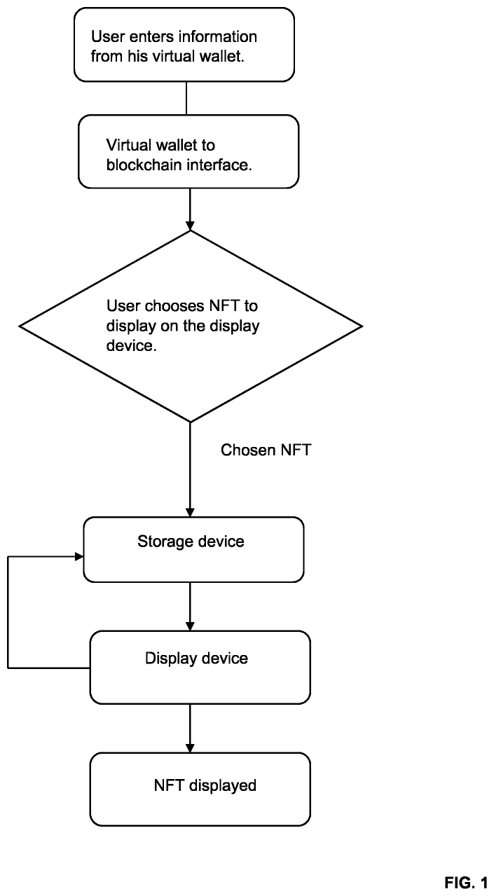

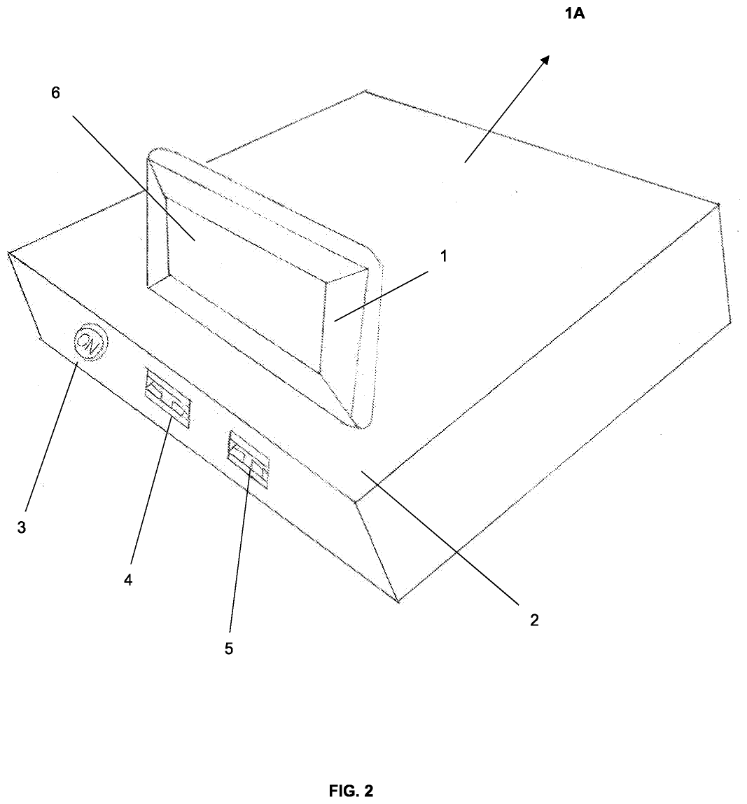

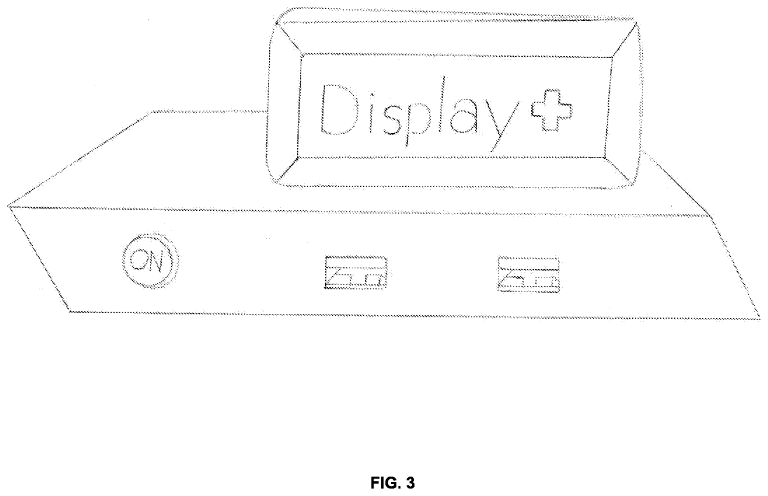

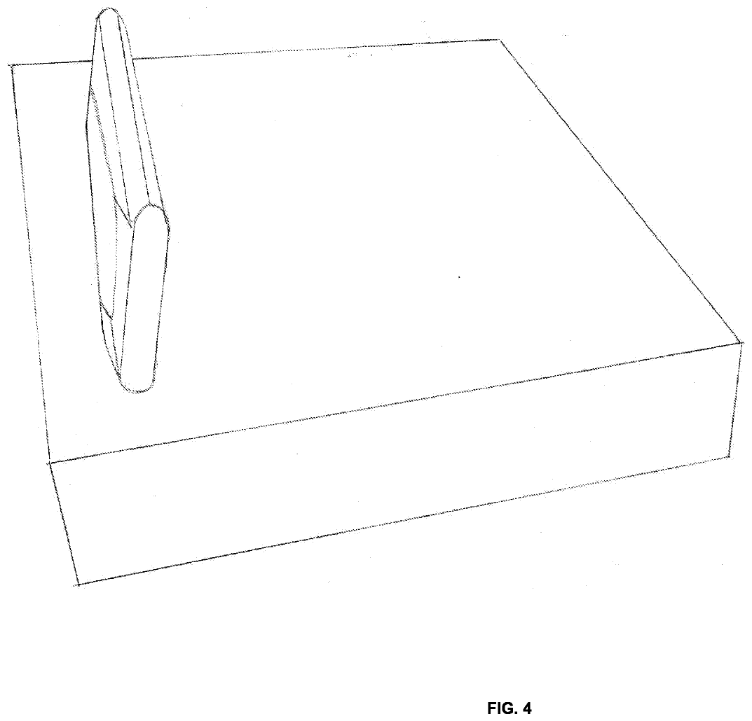

One embodiment of the subject disclosure relates to an NFT display device 1A, as shown or described in FIGS. 1-4. The NFT display device 1A comprises a user interface tactile or touch system 1, a monitor 6, and a storage unit (hard disk and RAM memory) and processor stored within a housing 2. The housing 2, in turn, comprises a power button 3, a USB port 4 and a power connector port 5 for supplying power to the NFT display device 1A. The system allows the projection of holograms designed as such, or of photographs that are converted to holograms, by reading the information contained in the virtual wallet. Once the system has downloaded the block verification, the device disconnects from the internet and transmits the information to the projection device (monitor), which increases security.

Upon power up, the device will first require the virtual wallet information to be entered, which will be entered through an internet connection. Once there, the user will choose between the NFTs that the wallet has at that moment, to carry out its projection. At the time the NFT is chosen and validated, the digital information of the NFT is saved in the device and the internet connection is closed, to increase security.

Until now, devices for displaying an NFT file must constantly make a connection to a computer in order to perform projection, or project information already contained in the device. The novelty of the subject disclosure resides in the fact that it discloses a device that can enter the blockchain and wirelessly and without requiring other devices, can project the NFT file directly from the virtual wallet. The NFT display device 1A is capable of displaying the NFTs as decorations in the house, just like a statue, and also have access to all the NFTs whose owners keep them in their virtual wallets.

The NFT display device 1A comprises internal components capable of reading information from the blockchain, specifically data contained in an NFT. These components include a user interface component and a storage unit that interact harmoniously with each other to turn digital art into a real life item.

The specifications for the NFT display device 1A include:
User Interface: Mechanism with a touch screen that uses a native or open-source software system to perform the interaction with the user, so that the user can enter his virtual profile of the Blockchain (virtual wallet) and select the address of the Blockchain profile whose NFTs the user will visualize.
Temporary storage unit: RAM (Random Access Memory) card with a capacity of at least 4 GB.
Storage unit: HDD (Hard Drive Disk) or SDD (Solid State Drive) storage unit with a capacity of at least 125 GB.
Processing Unit: Storage unit of at least 1 GB.
Video card: A VRAM (Video Random Access Memory) video card of at least 1 GB
Ports and external connections: Power cable connection, USB port, HDMI port.

B. NFT Holographic Projector

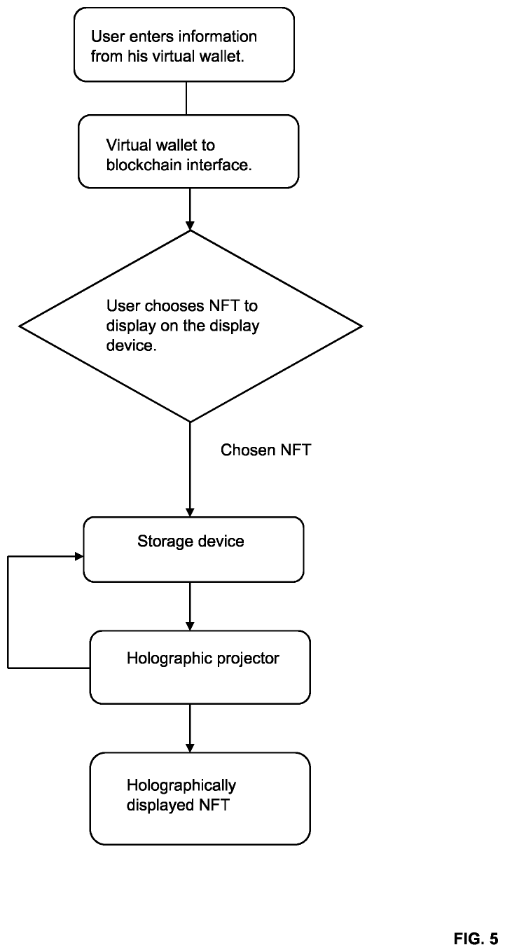

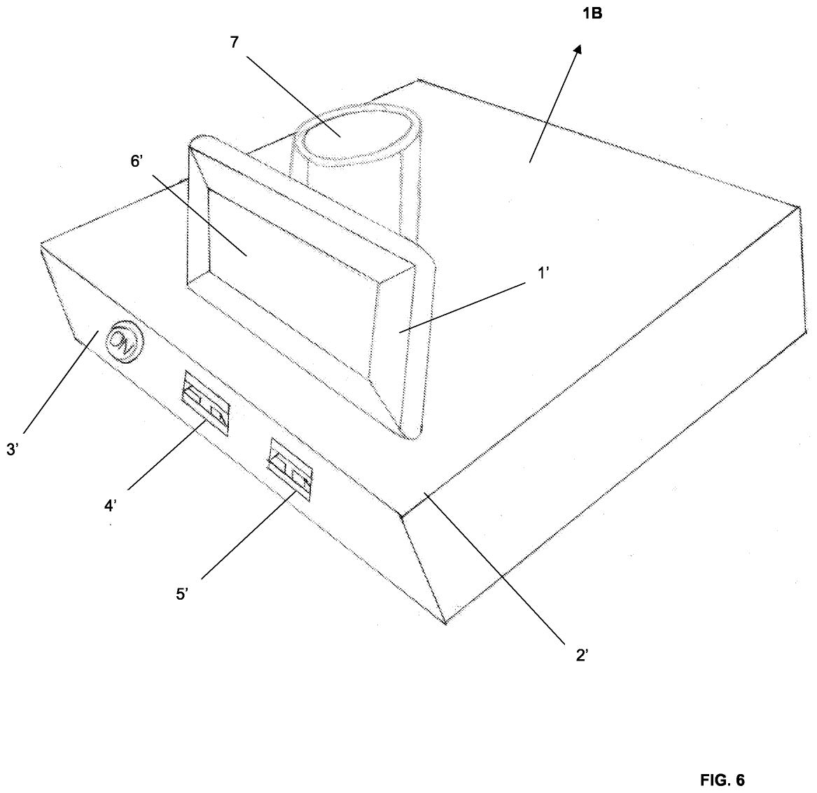

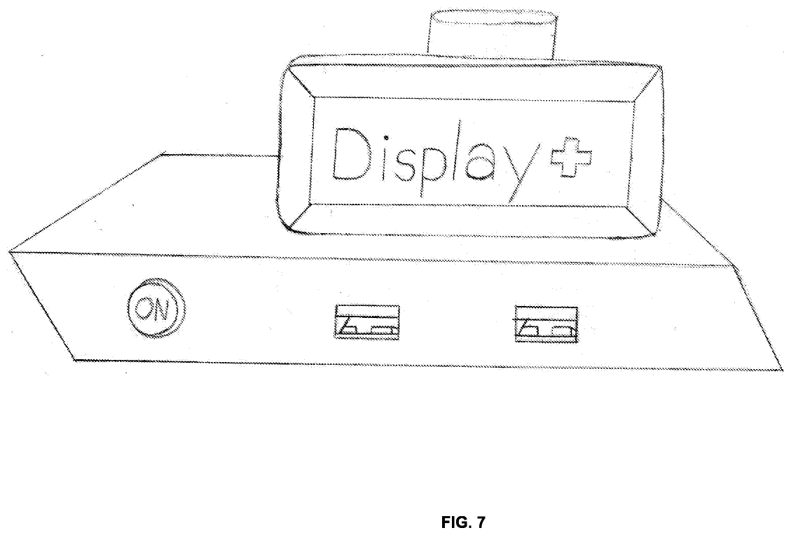

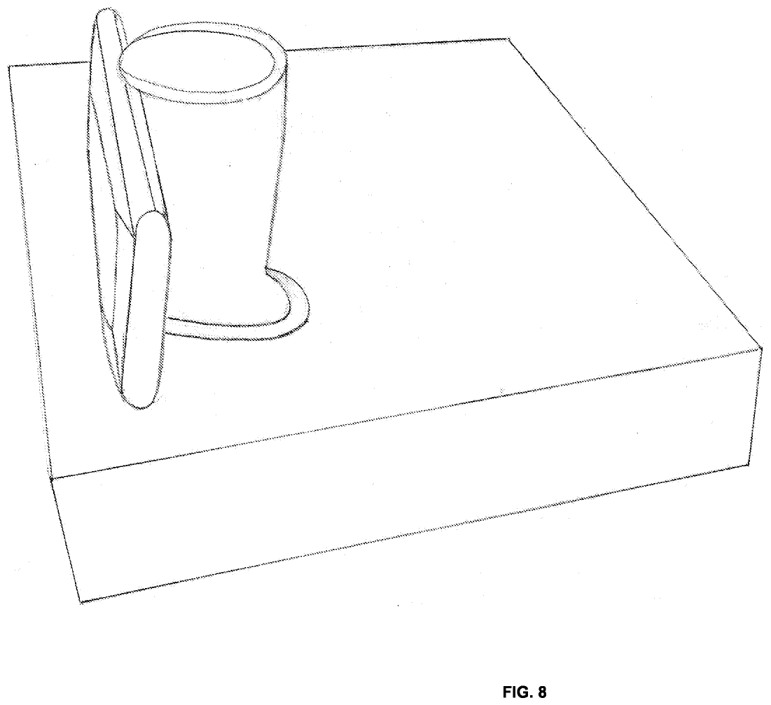

Another embodiment of the subject disclosure relates to an NFT holographic projector 1B, as shown or described in FIGS. 5-8. The NFT holographic projector 1B comprises a hologram projection lens 7 that uses a holographic projection technology (laser diodes, or turbine with synchronized LED lights); wherein the NFT holographic projector 1B further comprises an interface 1′ (e.g., touch screen), a monitor 6′, and a storage unit and processor (hard disk and RAM memory) stored within a housing 2′. The housing 2′, in turn, comprises a power button 3′, a USB port 4′ and a power connector port 5′ for supplying power to the NFT holographic projector 1B. The NFT holographic projector 1B allows for the projection of holograms designed as such, or of photographs that are converted to holograms, by reading the information contained in the virtual wallet.

Once the NFT holographic projector 1B has downloaded the block verification, the device disconnects from the internet and performs the holographic projection, which increases security.

Upon power up, the NFT holographic projector 1B will first require the virtual wallet information to be entered via an internet connection. Once there, the user will choose between the NFTs that the wallet has at that moment, to carry out its projection. At the moment the NFT is chosen and validated, the digital information of the NFT is saved in the device and the internet connection is closed, to increase security.

Until now, hologram projectors must constantly make a connection to a computer in order to project, like a monitor does, or they project information already contained in the device. The novelty of the NFT holographic projector 1B resides in the fact that it can enter the blockchain and wirelessly and without requiring other devices, can project a hologram directly from the virtual wallet. The goal of the NFT holographic projector 1B is to display the holographic NFTs as decorations in the house, just like a statue, and also have access to all the NFTs whose owners keep them in their virtual wallets.

The NFT holographic projector 1B comprises internal components capable of reading information from the blockchain, specifically data contained in an NFT. To achieve this, it is necessary to perform a combination of various electronic components (internet serial receiver, data and graphics processor, battery, holographic projection system) harmoniously to convert digital art (which can only be viewed on a screen) into a real life item.

The NFT holographic projector 1B is an electronic device that projects a hologram from a holographic projector incorporated in the system. Technologies similar to those of DVD Player or Play Station are combined with Blockchain technology and a holographic projector. The holographic projector 1B projects a hologram from a storage device (internal, as in the case of Play Station 4, for example). The holographic projector 1B, like the Play Station 4, connects to the internet and can interact with different web pages and databases, however, the difference is that the Projector contains a storage unit that allows you to download a Blockchain validation to verify the authenticity of the hologram being displayed.

The Projector connects directly to the blockchain and validates the blockchain information through any of the methods that currently exist (there are many, but for example you can use NFT blockchain access systems such as Metamask, Coinbase Wallet, Alpha Wallet, or others).

The holographic projector 1B gives the user the possibility to enter their own virtual wallet or to create one through a form, using any of the methods already indicated or any other new method that may arise (just as the Play Station 4 uses applications to connect to services such as Netflix or YouTube). The holographic projector 1B, however, differs from a Play Station 4 in that it is specifically designed to be able to validate the blockchain, which is done by downloading a full or condensed version of the blockchain to be used (Ethereum blockchain or other emerging blockchains). in the future) and certifies the authenticity of the NFT being observed. The holographic projector 1B allows anyone, regardless of their technical capacity in relation to the Blockchain, to access authentic NFTs, duly identified and validated by the Blockchain.

The holographic projector 1B acquires access to the Blockchain, validates the information, updates the information so that the user sees the NFTs on the Blockchain in real time, and once they choose one, the holographic projector 1B saves a copy in its RAM so that it can be accessed. display on the holographic projector. In case the user wants to search for another NFT, the information in the RAM memory is deleted and the blockchain is validated again so that it is always up to date. This is comparable to a television, where one changes the channels (which could be compared to changing the virtual wallet being seen by the user), however, unlike television, the holographic projector 1B does not need to be constantly connected to the internet, because it can display the last NFT that was visited through of the platform.

The holographic projector 1B is a product whose predecessor could be said to be the DVD Player. The DVD player works with a DVD reader (Digital Versatile Disc), which is basically a reader of data on a disc. The holographic projector 1B also displays information contained in a storage device, the difference is that the holographic projector 1B has the necessary components to validate the Blockchain information, in addition to a hologram projector and thus guarantee that the displayed content is authentic.

The specifications for the NFT Holographic Projector 1B include:
User Interface: Mechanism with a touch screen that will use a native or open source software system to perform the interaction with the user, so that the user can enter his virtual profile of the Blockchain (virtual wallet) and select the address of the Blockchain profile whose NFTs the user will visualize.
Temporary storage unit: RAM (Random Access Memory) card with a capacity of at least 4 GB.
Storage unit: HDD (Hard Drive Disk) or SDD (Solid State Drive) storage unit with a capacity of at least 125 GB.
Processing Unit: Storage unit of at least 1 GB.
Video card: A VRAM (Video Random Access Memory) video card of at least 1 GB. at least 1 GB.
Ports and external connections: Power cable connection, USB port, HDMI port.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. An NFT display device, comprising:
a housing;
a user interface;
a monitor;
a processor;
a storage unit comprising a hard disk and RAM memory stored within the housing;
wherein the housing comprises a power button, a USB port, and a power connector port for supplying power to the NFT display device;
wherein the storage unit contains instructions, which when performed by the processor, validate Blockchain information and verify that an NFT displayed on the monitor is authentic.

2. The NFT display device of claim 1, wherein the user interface is a touch screen adapted to receive input from a user.

3. The NFT display device of claim 1, wherein the monitor can display NFTs from an e-wallet.

4. The NFT display device of claim 1, wherein the monitor further comprises an HDMI connector.

5. An NFT holographic projector, comprising:
a housing;
a hologram projection lens;
a user interface;
a monitor;
a processor;
a storage unit comprising a hard disk and RAM memory stored within the housing;
wherein the housing comprises a power button, a USB port, and a power connector port for supplying power to the NFT holographic projector;
wherein the storage unit contains instructions, which when performed by the processor, validate Blockchain information and verify that an NFT projected on the hologram projection lens is authentic.

6. The NFT holographic projector of claim 5, wherein the user interface is a touch screen adapted to receive input from a user.

7. The NFT holographic projector of claim 5, wherein the hologram projection lens can display NFTs from an e-wallet.

8. The NFT holographic projector of claim 5, wherein the monitor further comprises an HDMI connector.
